(19) United States
(12) Patent Application Publication
(10) Pub. No.: US 2011/0219742 A1
(43) Pub. Date: Sep. 15, 2011

(54) SUPERSONIC COMBUSTOR ROCKET NOZZLE

(75) Inventor: Gregory S. Mungas, Mojave, CA (US)

(73) Assignee: Firestar Engineering, LLC, Mojave, CA (US)

(21) Appl. No.: 13/047,663

(22) Filed: Mar. 14, 2011

Related U.S. Application Data
(60) Provisional application No. 61/313,650, filed on Mar. 12, 2010.

(51) Int. Cl. F02K 9/97

(52) U.S. Cl. 60/204; 60/770

(57) ABSTRACT

A supersonic combustor as a component of a rocket nozzle offers improved utilization of available chemical energy that may be released from combustion gasses flowing through the rocket nozzle. A subsonic combustor sub-sonically accelerates an exothermically reacting combustion gas up to a nozzle throat. The supersonic combustor expands and super-sonically accelerates the exothermically reacting combustion gas beyond the nozzle throat. The dimensions of the supersonic combustor may be selected such that the supersonic combustor achieves a slow rate of cooling of the combustion gasses without creating shockwaves within the supersonic combustor. A supersonic discharge expands and super-sonically accelerates the now substantially non-reacting combustion gas through a supersonic discharge of the rocket nozzle. The momentum of the combustion gas leaving the supersonic discharge propels the rocket nozzle in the opposite direction due to the principle of conservation of momentum.

### CROSS-REFERENCE TO RELATED APPLICATIONS

The present application claims benefit of priority to U.S. Provisional Patent Application No. 61/313,650, entitled “Supersonic Combustor Rocket Nozzle” and filed on Mar. 12, 2010, which is specifically incorporated by reference herein for all that it discloses or teaches.

### BACKGROUND

The art of chemical rocket propulsion makes use of controlled release of chemically reacted or un-reacted fluids through a rocket nozzle to achieve thrust in a desired direction. The thrust acts to change a body's linear or angular momentum, and there are multiple methods for using chemical propellants to achieve thrust.

Conventional rocket nozzles are designed to minimize the formation of shock waves primarily with non-reacting gas flows. Shockwaves and other flow losses (e.g., viscous wall interactions) are undesirable in that they readily convert useful, focused gas velocity (and thrust) into random gas velocity (i.e., heat). Conventional rocket nozzles are designed to primarily prevent supersonic shockwave formation with a minimal nozzle length. This may be accomplished by creating a rapid nozzle expansion to large nozzle diameters immediately downstream of a throat of the rocket nozzle. Rapid nozzle expansion, however, causes combustion gas static pressure and temperature to drop rapidly and “freeze” (i.e., stop or substantially slow) the gasses' chemical reaction rates in the vicinity of the rapid expansion.

Slower cooling rates would allow the reacting gas to maintain chemical reaction rates necessary to effectively extract more of the available chemical energy associated with shifting gas chemical equilibrium (as the gas pressure and/or temperature changes or “shifts” in the rocket nozzle, the chemistry of the gas will tend to change as well). In the rocket nozzle's shifting chemical equilibrium, lower gas temperatures generate lower energy gas chemistry. As the gas chemistry is changed to a lower energy state, chemical energy is released. The released chemical energy adds additional heat to the gas flow. This additional heat may be guided in a nozzle to further accelerate gasses and provide additional thrust to the rocket nozzle.

In conventional rocket nozzles, a significant amount of additional unutilized chemical energy may remain in the nozzle discharge. That chemical energy may have been more fully reacted if it were not for the rapid cooling in the rapid nozzle expansion downstream of the nozzle throat. Further, this additional chemical energy is not available for extraction in a traditional subsonic combustion chamber upstream of the nozzle throat where changes in the local gas pressure and temperature (and therefore changes to the chemical equilibrium of the gas) are minimal.

### SUMMARY

Implementations described and claimed herein address the foregoing problems by providing a rocket nozzle with a supersonic combustor oriented downstream of a rocket nozzle throat of the rocket nozzle and configured to extract exothermic chemical energy from a combustion gas accelerating at supersonic speeds. Further, the supersonic combustor may be used in conjunction with a subsonic combustor configured to extract exothermic chemical energy from a combustion gas accelerating at subsonic speeds and a supersonic discharge configured to discharge the combustion gas accelerating at supersonic speeds.

Other implementations are also described and recited herein.

### BRIEF DESCRIPTIONS OF THE DRAWINGS

FIG. 1A is a perspective view of an orbital vehicle or spacecraft with several attitude or apogee thrusters with example supersonic combustor rocket nozzles.

FIG. 1B is a propulsion system in an orbital vehicle or spacecraft using an example supersonic combustor rocket nozzle.

FIG. 2 illustrates a combustion gas flow through an example supersonic combustor rocket nozzle.

FIG. 3A illustrates an example reactive gas mole fraction graph.

FIG. 3B illustrates an example stagnation temperature graph.

FIG. 4A illustrates an example conical supersonic combustor flow geometry.

FIG. 4B illustrates an example differential gas element of the conical supersonic combustor of FIG. 4A.

FIG. 5 illustrates example operations for extracting exothermic energy from a combustion gas within a supersonic combustor rocket nozzle.

### DETAILED DESCRIPTIONS

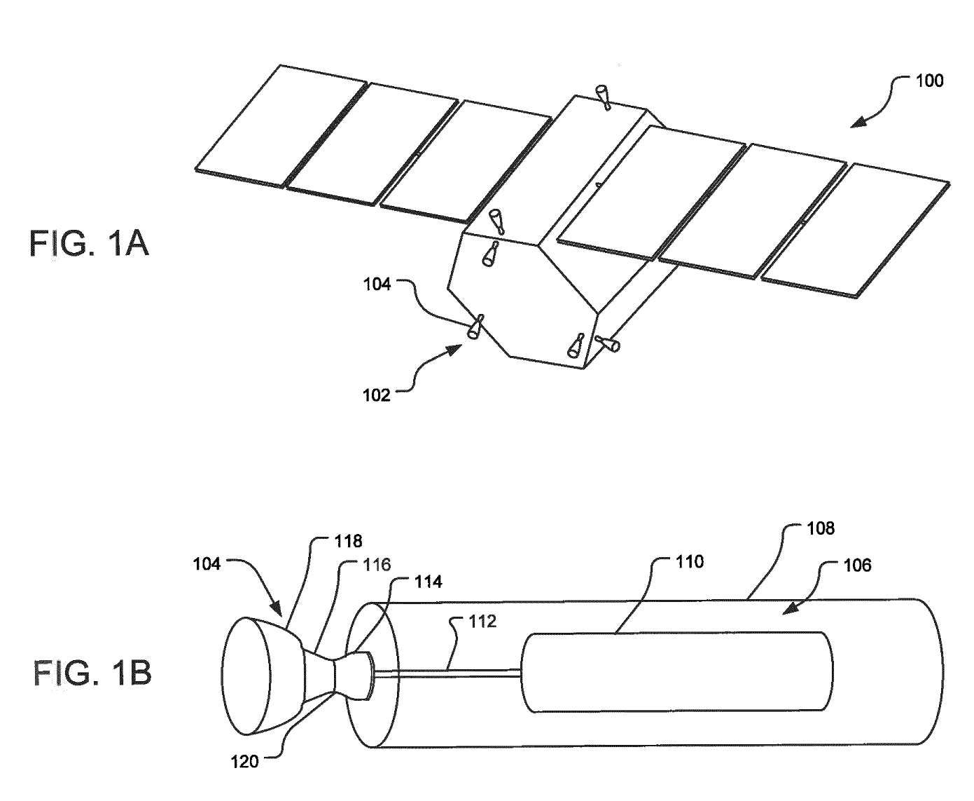

FIG. 1A is a perspective view of an orbital vehicle or spacecraft 100 with several attitude or apogee thrusters (e.g., thruster 102) with example supersonic combustor rocket nozzles (e.g., nozzle 104). The thrusters are used to adjust the position and/or orientation of the spacecraft 100 by discharging focused combustion gasses. The supersonic combustor rocket nozzles improve the efficiency and/or power output of the thrusters by utilizing more of the shifting gas chemical equilibrium of the combustion gasses than a traditional rocket nozzle. The thrusters may be bimodal and rely on chemical and/or electric propulsion. The supersonic combustor rocket nozzle 104 is depicted in more detail in FIG. 1B.

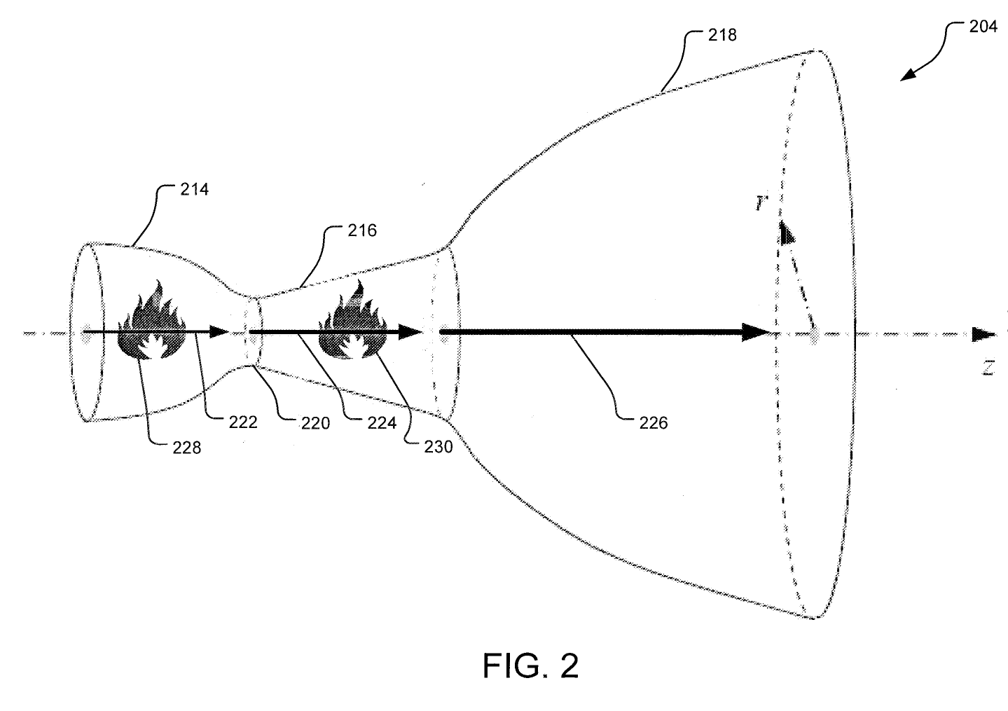

FIG. 1B is a propulsion system 106 in an orbital vehicle or spacecraft 108 using an example supersonic combustor rocket nozzle 104. The example propulsion system 106 includes fuel and/or oxidizer tanks 110 that provide fuel and/or oxidizer to the supersonic combustor rocket nozzle 104 via ignition interface 112. The ignition interface 112 is located between the fuel and/or oxidizer tanks 110 and the supersonic combustor rocket nozzle 104. The supersonic combustor rocket nozzle 104 includes a subsonic combustor 114, a supersonic combustor 116, and a supersonic discharge 118, which wilt be discussed in more detail with regard to FIGS. 2-5. A throat 120 corresponding to the smallest cross-sectional area of the supersonic combustor rocket nozzle 104 is oriented between the subsonic combustor 114 and the supersonic combustor 116. The propulsion system 106 may be bimodal and rely on chemical and/or electric propulsion.

In the illustration, the orbital vehicle 108 would be propelled from left to right during operation of the propulsion system 106. Note that while the supersonic combustor rocket nozzle 104 is depicted in FIGS. 1A and 1B in conjunction with an orbital vehicle or spacecraft 100, 108, the supersonic combustor rocket nozzle 104 may also be used in other vehicles or power generation systems.

FIG. 2 illustrates a combustion gas flow (illustrated by arrows 222, 224, 226) through an example supersonic combustor rocket nozzle 204. The supersonic combustor rocket nozzle 204 includes a subsonic combustor 214, a supersonic combustor 216, and a supersonic discharge 218, each of which are defined by the state of combustion gases flowing there through. As the combustion gas (see arrow 222) enters and flows through the subsonic combustor 214 in the z-direction, it is traveling at subsonic velocities and accelerating due to reduction of nozzle cross-sectional area and the combustion gases chemically reacting to release heat via combustion (illustrated by flame 228). As the subsonic combustor 214 contracts down in the radial r-direction, the combustion gas flow is forced to further accelerate until at a nozzle throat 220, where the cross-sectional area is the smallest, the linear velocity of the combustion gas flow becomes sonic (i.e., meets the speed of sound). For example, the speed of sound in dry air at 20 degree Celsius is approximately 343.2 meters per second. At elevated temperatures, the sonic velocity increases. In the subsonic combustor 214 the combustion gas flow is subsonic, substantially combusting and releasing energy into the combustion gas flow, and increasing in velocity up to the sonic point.

The supersonic combustor 216 connects to the subsonic combustor 214 at the throat 220. In some implementations, the supersonic combustor 216 has a conical interior wall that linearly increases in diameter from the nozzle throat 220 in the direction of combustion gas flow (see arrow 224). In other implementations, the supersonic combustor 216 merely has a monotonically increasing cross-sectional area in the z-direction. From the throat 220, the combustion gas flow expands and the linear velocity of the combustion gas flow becomes progressively more supersonic in the z-direction. Expansion of the combustion gas flow in the z-direction and in the radial r-direction causes the combustion gas flow temperature and pressure to decay even while the combustion gas flow is being heated by continuing combustion as explained below.

However, the gradually increasing diameter of the supersonic combustor 216 prevents the combustion gas flow from expanding (and thus cooling) so quickly that combustion of the combustion gasses ceases. More specifically, the supersonic combustor 216 slows the expansion rate of the combustion gases such that there is a more moderate change in gas pressure and temperature downstream of the throat 220. Higher temperatures and higher pressures tend to increase associated chemical combustion reaction rates. The slower gas cooling and pressure reduction rate provides a slower shifting pressure/temperature chemical equilibrium from which additional available chemical energy ultimately may be derived using the supersonic combustor 216. Furthermore, the slower gas cooling and pressure reduction rate within the supersonic combustor 216 (as compared to the supersonic discharge 218 discussed below) maintains faster chemical reaction rates such that there is sufficient time for the combustion gas chemistry to equilibrate with the shifting equilibrium condition as the combustion gas flows through the supersonic combustor 216.

The shifting equilibrium conditions to lower energy states allows more chemical energy to be released into the combustion gas flow as long as the chemical reaction rates are sufficiently fast. In the combustion gas flow, this chemical energy may be associated with changes in molecular chemistry to constituent molecules with less energy stored in chemical bonds. In combustion gases that are dissociated or ionized, this exothermic chemical energy can include a recombination energy of dissociated or ionized species.

The supersonic combustor 216 has higher viscous wall interaction flow losses associated with maintaining a smaller section diameter for a longer portion of the supersonic combustor rocket nozzle 204 (as compared to the supersonic discharge 218 discussed below), however, these viscous losses are more than offset by the additional released chemical energy. To minimize supersonic flow losses, the supersonic combustor 216 employs geometry to avoid the formation of shockwaves (i.e., the combustion gas flow is not allowed to “turn-in” to itself). In one implementation, the supersonic combustor 216 has either a constant expansion angle and/or a monotonically increasing expansion angle as measured from a centerline (e.g., the z-axis depicted in FIG. 2) of the supersonic combustor 216. In another implementation, the supersonic combustor 216 contour with the slowest rate of cooling which does not cause shockwave formation is a conical divergent nozzle as depicted in FIG. 2. In the supersonic combustor 216 the combustion gas flow is supersonic, substantially combusting (illustrated by flame 230), and further increasing in velocity.

In one implementation using a circularly symmetric nozzle profile, the supersonic combustor 216 has a maximum area expansion ratio of greater than 1.025 of the area ratio of the throat 220 and a maximum area ratio less than 25 of the area ratio of the throat 220. This controlled expansion provides for a significant increase in the release of exothermic chemical energy over conventional rocket nozzle designs. In another implementation, the supersonic combustor 216 has a nozzle expansion ratio greater than 25 of the area ratio of the throat 220. In other implementations, similar constraints apply to asymmetric nozzle profiles (e.g., square nozzle cross-sections) with similar area ratios.

The supersonic discharge 218 connects to the outlet of the supersonic combustor 216. The combustion gas flow (see arrow 226) continues to increase in velocity in the z-direction through the supersonic combustor 216 by effectively converting thermal energy in the combustion gasses to combustion gas flow velocity. However, since the supersonic discharge 218 increases the rate of expansion of the combustion gas flow in the radial r-direction, the combustion gas flow is cooled sufficiently to effectively cease combustion of the combustion gas flow. Therefore, the supersonic discharge 218 is primarily designed based on a combustion gas flow that is non-reacting. In the supersonic discharge 218, the combustion gas flow is supersonic, substantially combusted (i.e., there is little energy left to extract), and the gas chemistry is relatively fixed. Further, in the supersonic discharge 218 the combustion gasses are further accelerated to a high velocity with minimal shockwave formation in a minimal length and an output where the combustion gases are primarily oriented in the z-direction. The combustion gas flow exits the supersonic discharge 218 at a high rate of speed in the z-direction to produce the maximum axial thrust of the nozzle 204 in the negative z-direction. In one implementation, the supersonic discharge 218 uses a Rao supersonic nozzle profile. In another implementation, supersonic discharge 218 uses a modified Rao supersonic nozzle profile. The modified Rao supersonic nozzle profile accounts for different curvature of the combustion gas profile in the nozzle 204 entering the supersonic discharge 218 as compared to a conventional nozzle discharge, which is typically directly attached to the throat of the conventional nozzle. In yet another implementation, the supersonic discharge 218 incorporates a conical nozzle profile. In still another implementation, the supersonic discharge 218 has a monotonically increasing nozzle diameter.

Due to conservation of momentum, the supersonic combustor rocket nozzle 204 is propelled in the negative z-direction as a result of the combustion gas discharge in the z-direction. The amount of exothermic energy released in the supersonic combustor rocket nozzle 204 is substantially greater than a conventional rocket nozzle without a supersonic combustor 216. The supersonic combustor rocket nozzle 204 ultimately generates higher exhaust gas velocities and thus more thrust than the conventional rocket nozzle without a supersonic combustor 216.

As mentioned above, a significant amount of additional exothermic chemical energy may be released within a supersonic combustor 216 with an expansion ratio less than a typical rocket nozzle supersonic discharge. In some implementations, this additional exothermic chemical energy is primarily available in nozzle diameters less than a multiple of 5 of the throat 120 diameter. To release this chemical energy, expansion of the cross-sectional area perpendicular to the z-direction of the supersonic combustor 216 is sufficiently gradual to prevent rapid gas expansion cooling and pressure reduction of the combustion gasses in the supersonic combustor 216 from “freezing” the chemistry reaction rates inside the supersonic combustor 216.

At elevated temperatures, a chemical mixture in equilibrium tends to form molecular species that have more energy contained in various forms (e.g., chemical bonds between atoms in a molecule and dissociated and ionized species). For example, at elevated temperatures H₂O may dissociate into H₂ and O₂. Further, at lower temperatures, H₂ and O₂ may react to form H₂O and liberate heat.

For hydrocarbon combustion chemistry used in a rocket nozzle, example chemical constituents within the combustion gas includes O, H, NO, OH, O₂, H₂, CO, CO₂, and H₂O. At higher temperatures, additional chemical constituents may also include ionized versions of these species. As the equilibrium condition of the combustion gas shifts with lower pressure and temperature, the percent makeup of the combustion gas changes to include mostly lower energy chemical compositions (e.g., H₂, CO, CO₂, and H₂O). The difference in energy between the high temperature hydrocarbon combustion chemistry and the lower temperature hydrocarbon combustion chemistry corresponds to the available chemical energy that may be released into a combustion gas flow using a supersonic combustor. In other rocket engine propellant formulations, the gas chemistry may vary, but the release of energy into the combustion gas flow with lower pressure and/or temperature remains the same.

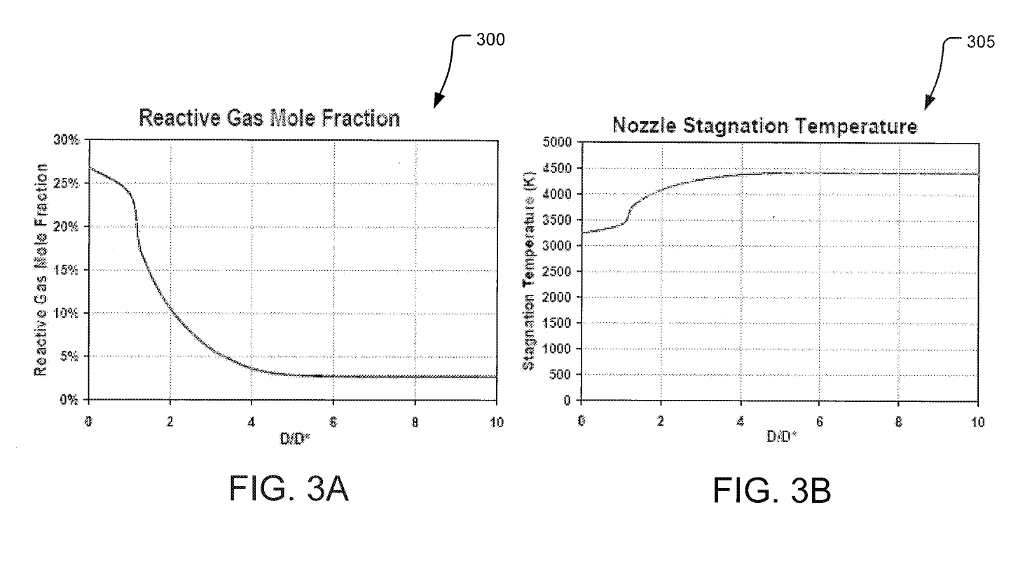

FIG. 3A illustrates an example reactive gas mole fraction graph 300. Graph 300 illustrates the reactive gas mole fraction within combustion gasses in a supersonic combustor rocket nozzle as a function of position along the length of the nozzle (e.g., the z-axis of FIG. 2) as described by the local nozzle diameter ratio. The nozzle diameter ratio is a non-dimensional metric of the ratio between changing nozzle diameter (D) and the fixed throat diameter (D*) of the supersonic combustor rocket nozzle. As depicted by the graph, substantial reactive gas mole fraction changes occur up to about D/D*=5 (or a nozzle diameter equaling 5 times the throat diameter). The presently disclosed supersonic combustors take advantage of additional exothermic chemical energy released downstream of a rocket nozzle throat illustrated by the reactive gas mole fraction changes up to D/D* approximately equaling 5 in FIG. 3A.

In other implementations, a nozzle area ratio (i.e., a non-dimensional metric of the ratio between changing nozzle area (A) and the fixed throat area (A*) of the supersonic combustor rocket nozzle) may be used in lieu of the nozzle diameter ratio. In one implementation, D/D*=5 of an axisymmetric nozzle is approximately equivalent to a nozzle area ratio A/A*=25.

FIG. 3B illustrates an example stagnation temperature graph 305. Graph 305 illustrates the stagnation temperature of the combustion gasses in a supersonic combustor rocket nozzle as a function of position along the length of the nozzle (e.g., the z-axis of FIG. 2) as described by the local nozzle diameter ratio. The nozzle diameter ratio is a non-dimensional metric of the ratio between changing nozzle diameter (D) and the fixed throat diameter (D*) of the supersonic combustor rocket nozzle. As depicted by the graph, the stagnation temperature of the combustion gasses within the supersonic combustor rocket nozzle increases up to D/D* approximately equaling 5 (or a nozzle diameter equaling 5 times the throat diameter). The presently disclosed supersonic combustors take advantage of additional exothermic chemical energy released downstream of a rocket nozzle throat illustrated by the increase in stagnation temperature of the combustion gasses up to about D/D*=5 in FIG. 3B. In other implementations, a nozzle area ratio may be used in lieu of the nozzle diameter ratio as discussed above.

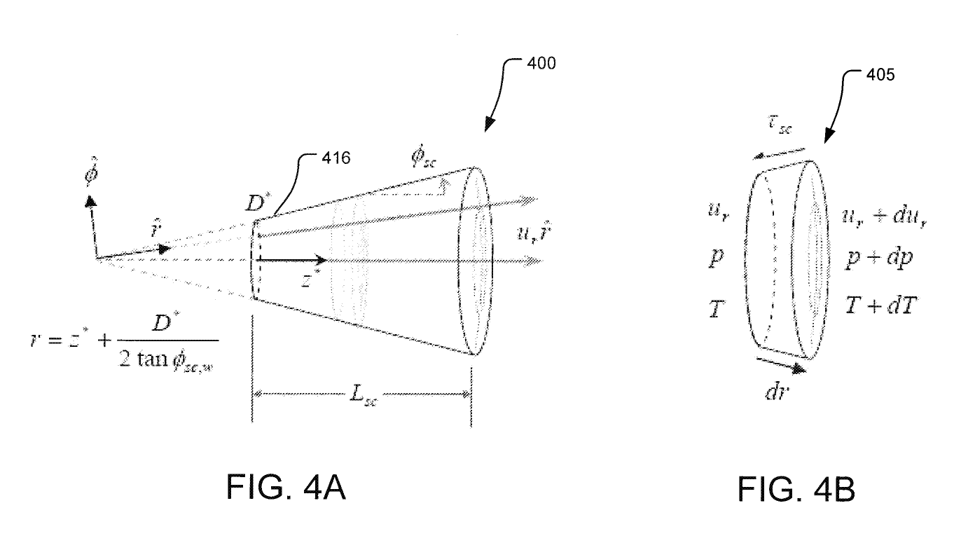

FIG. 4A illustrates an example conical supersonic combustor 416 flow geometry 400. In a shock-free supersonic combustor 416, the internal wall contour does not turn the supersonic combustion gas flow into itself (i.e., deflect the combustion gas flow toward the local velocity vector). Even very minor turns of the supersonic gas stream into itself generate very strong shock waves. Such shockwaves significantly reduce combustion gas velocity contained within the combustion gas flow.

In the supersonic discharge, shockwaves may be cancelled with the strong Prandtl-Meyer expansion fan that is produced at the sharp turning angle at the interface between the supersonic combustor and the supersonic discharge (see e.g., FIG. 2). The Prandtl-Meyer expansion fan in the supersonic combustor is insufficient to cancel any shockwaves developed within the supersonic combustor. As a result, once the combustion gas flow is turned away from a throat of the supersonic combustor rocket nozzle, until the combustion gas flow reaches a supersonic discharge of the supersonic combustor rocket nozzle, the combustion gas flow should not be turned into itself. More specifically, the supersonic combustor is designed such that shockwaves are not allowed to develop in the supersonic combustor.

Further consideration for the design of the internal wall contour of the supersonic combustor is the chemical kinetics rate for releasing thermal energy into the combustion gas as the combustion gasses are expanded and cooled. The ideal internal wall contour for releasing thermal energy into the combustion gas will drive the internal wall contour to turn into itself (i.e., have a narrowing cross-sectional area when moving in the direction of combustion gas flow) in order to lengthen the residence time of the combustion gas within the supersonic combustor. However, as discussed above, turning the gas into itself within the supersonic combustor creates shockwaves. As a result, an ideal supersonic combustor achieves the slowest rate of cooling and reduction of gas pressure of the combustion gasses without creating shockwaves within the supersonic combustor. In one implementation, the ideal supersonic combustor is a conical supersonic combustor 416 as shown in FIG. 4A.

The shape of the conical supersonic combustor 416 is driven by the throat diameter (D*), the supersonic combustor length (L_{sc}) and the supersonic combustor expansion angle (φ_{sc}). The supersonic combustor expansion angle is not arbitrarily shallow due to viscous losses caused by interaction of the combustion gas with the internal wall contour that dissipates energy and momentum in the boundary layer between the supersonic combustor and the combustion gas. These viscous losses may offset gains in chemical energy input into the combustion gas flow. Further, arbitrarily shallow supersonic combustor expansion angles may yield a particularly long supersonic combustor, which may be undesirable for packaging purposes.

Interplay between viscous losses caused by small supersonic combustor expansion angles and reduction in gains in chemical energy caused by large supersonic combustor expansion angles is analyzed below. In the analysis, combustion gas flow through the supersonic combustor is described in a spherical coordinate system centered about the intersection of projections of supersonic combustor boundary wall contour lines as depicted in FIG. 4A.

Regarding continuity, for steady-state flow through a supersonic combustor, Conservation of Mass dictates that

\vec{Δ}·(ρ\vec{μ})=0; (1)

wherein \vec{Δ} is a Divergence Operator, ρ equals the local fluid density, and \vec{μ} equals the local velocity vector. This vector relationship defines that under steady-state conditions, a gas mass entering a differential volume is equal to the fluid mass exiting the same volume.

Substituting in the ideal gas law and solving the equation (1) in spherical coordinates yields

$$2 \frac{{u}_{r}}{r} + \frac{{u}_{r}}{p} \frac{\partial p}{\partial r} + \frac{\partial {u}_{r}}{\partial r} - \frac{{u}_{r}}{T} \frac{\partial T}{\partial r} = 0 ; \qquad ( 2 )$$

wherein uᵣ is the radial component of gas velocity in spherical coordinates, r is the radius as measured In spherical coordinates, p equals the local pressure in a gas element, and T equals the local temperature in a gas element.

For steady-state flow through the supersonic combustor, Conservation of Momentum dictates that

$${∮}_{S} \int ( ρ \vec{u} \cdot d \vec{S} ) \vec{u} = - {∮}_{S} \int p d \vec{S} + {\vec{F}}_{viscous} ; \qquad ( 3 )$$

wherein d\vec{S} is a differential surface area patch element of an enclosed fluid volume, and \vec{F}_{viscous} is the total drag force due to viscous fluid interaction with the gas element.

FIG. 4B illustrates an example differential gas element of the conical supersonic combustor of FIG. 4A. The differential gas element of FIG. 4B is utilized in the analysis below.

For relatively shallow supersonic combustor expansion angles, the Prandtl-Meyer expansion fan produced at the interface between the throat and the supersonic combustor forms a local Mach angle steep enough (e.g., approximately 90 degrees relative to the wall surface) that with subsequent internal wall reflections ∂p/∂φ≈∂uᵣ/∂φ≈0. This relationship holds true except in the small subsonic viscous boundary layer of the wall of the supersonic combustor. Neglecting the volume contribution of the very thin viscous boundary layer and solving equation (3) for a conical differential radial gas element (see e.g., FIG. 4B) yields

$$\dot{m} {du}_{r} = - 2 π {r}^{2} ( 1 - cos {φ}_{sc} ) dp - \frac{{C}_{f}}{2} ρ {u}_{r}^{2} ( 2 π r sin {φ}_{sc} ) dr ; \qquad ( 4 )$$

wherein \dot{m} equals the total mass flow rate moving through the nozzle and C_{f} equals a coefficient of friction for internal pipe flow.

$$\dot{m} = {∮}_{S} \int ( ρ \vec{u} \cdot d \vec{S} ) = 2 π ( 1 - cos {φ}_{sc} ) {r}^{2} ρ {u}_{r}$$

Recognizing that and applying the ideal gas law, equation (4) may be reduced to

$$\frac{d {u}_{r}}{d r} = - \frac{RT}{{pu}_{r}} \frac{d p}{d r} - \frac{{C}_{f} sin {φ}_{sc}}{2 ( 1 - cos {φ}_{sc} )} \frac{{u}_{r}}{r} ; \qquad ( 5 )$$

wherein R equals the gas constant for the combustion gas.

The coefficient of friction as a function of Reynolds number (Re_{D}) for internal pipe flow has been determined for a wide operating range of Reynolds numbers, as follows

$${C}_{f} = \frac{0.25}{{( 0.790 ln {Re}_{D} - 1.64 )}^{2}} , where \\ {Re}_{D} = \frac{2 \dot{m}}{π {μ}_{r} r sin {φ}_{sc}} ; \qquad ( 6 )$$

wherein μᵣ equals the dynamic viscosity of the combustion gas, which changes with temperature and thus radial position within the nozzle.

For steady-state flow through the supersonic combustor, Conservation of Energy dictates that

$$\vec{∇} \cdot [ ( ρ e ( p , T ) + \frac{ρ {u}_{r}^{2}}{2} + p ) \vec{u} ] = ρ \dot{q} ; \qquad ( 7 )$$

wherein e is the total internal energy of the fluid element (made up of both thermal and chemical energy), and \dot{q} is the internal volumetric heating rate per unit mass deposited into a gas element.

For the spherical geometry of the supersonic combustor depicted in FIG. 4A, equation (7) may be reduced to

$$( \frac{{u}_{r}}{p} ) ( e + \frac{{u}_{r}^{2}}{2} + RT ) \frac{\partial p}{\partial r} + {u}_{r} ( {c}_{v , e} - \frac{e}{T} - \frac{{u}_{r}^{2}}{2 T} ) \frac{\partial T}{\partial r} + ( e + \frac{3 {u}_{r}^{2}}{2} + RT ) \frac{\partial {u}_{r}}{\partial r} = \dot{q} - 2 ( \frac{{u}_{r}}{r} ) ( e + \frac{{u}_{r}^{2}}{2} + RT ) ; \qquad ( 8 )$$

wherein c_{v,e} equals the constant volume specific heat, which includes both the sensible thermal energy and chemical energy associated with a differential change in temperature. This assumes the gas element is allowed to fully thermally equilibrate.

Equations 2, 5, and 8 can be combined and simplified to produce ordinary differential equations for the combustion gas static pressure, combustion gas free stream velocity, and combustion gas free stream temperature inside the supersonic combustor as follows

$$\begin{matrix}\frac{d p}{d r} = - ( \frac{γ {M}^{2} }{{M}^{2} - 1} ) [ \begin{matrix}2 - ( 1 + ( γ - 1 ) {M}^{2} ) ( \frac{{C}_{f} sin {φ}_{sc}}{2 ( 1 - cos {φ}_{sc} )} ) - \\ ( \frac{r}{{c}_{p , e} {Tu}_{r}} ) \dot{q}\end{matrix} ] ( \frac{p}{r} ) ; & ( 9 ) \\ \frac{d {u}_{r}}{d r} = ( \frac{1}{{M}^{2} - 1} ) [ 2 - γ {M}^{2} ( \frac{{C}_{f} sin {φ}_{sc}}{2 ( 1 - cos {φ}_{sc} )} ) - ( \frac{r}{{c}_{p , e} {Tu}_{r}} ) \dot{q} ] ( \frac{{u}_{r}}{r} ) ; & ( 10 ) \\ \frac{d T}{d r} = - ( \frac{( γ - 1 ) {M}^{2}}{{M}^{2} - 1} ) [ \begin{matrix}2 - γ {M}^{2} ( \frac{{C}_{f} sin {φ}_{sc}}{2 ( 1 - cos {φ}_{sc} )} ) - \\ ( \frac{γ {M}^{2} - 1}{( γ - 1 ) {M}^{2}} ) ( \frac{r}{{c}_{p , e} {Tu}_{r}} ) \dot{q}\end{matrix} ] \frac{T}{r} ; & ( 11 ) \\ where {M}^{2} = \frac{{u}_{r}^{2}}{γ RT} ; and & ( 12 )\end{matrix}$$

wherein c_{p,e} is the constant pressure specific heat, which includes both the sensible thermal energy and chemical energy associate with a differential change in temperature. This assumes that the gas element is allowed to fully thermally equilibrate and γ≡c_{p,e}/c_{v,e}.

In a chemically reacting fluid system that has sufficiently fast chemical reaction rates, the release of heat is limited by the rate at which the shifting equilibrium occurs as follows

\dot{q}=−\dot{h}_{rxn,e}; (13)

wherein \dot{h}_{rxn,e} is the rate of chemical energy release due to the shifting chemical equilibrium as the gas pressure and temperature changes while the combustion gas is moving through the supersonic combustor. Shifting equilibrium (shifting pressure and temperature) shifts the equilibrium chemical composition into a lower energy state, which liberates heat. In a shifting equilibrium system where the rates of chemical reaction to achieve the new equilibrium do not limit the reaction, the rate of change of pressure and temperature dictate the rate at which shifting equilibrium heat is released.

In an expanding nozzle wherein the combustion gas is rapidly monotonically cooling and the gas pressure is rapidly monotonically decreasing, the real chemical reaction rate, will rapidly decrease. Eventually these chemical reaction rates can slow down so much \dot{h}_{rxn,real} that the chemistry “freezes” and cannot keep up with the rates of chemical change necessary to keep up with the shifting equilibrium condition. Near the point of “freezing”, the combustion gas with finite chemical reaction rates slows its deposition of heat through chemical reaction into the gas flow relative to the shifting equilibrium scenario. This declining rate of heat deposition with this real reacting flow ensures that the combustion gas cools faster than the shifting equilibrium case. As gases cool, the chemical reaction rates slow. As a result, near this “freezing” transition the release of heat through exothermic reactions quickly “shuts off” and the chemistry of the gas flow becomes fixed or “frozen”. Therefore, the “freezing point” may be reasonable approximated by determining the location where

\dot{h}_{rxn,real}=\dot{h}_{rxn,e}; (14)

wherein \dot{h}_{rxn,real} is the rate of real chemical energy release into the gas flow for a particular gas chemistry at a particular temperature, pressure, and rate of change of both temperature and pressure.

It should be noted that while gas transport properties such as thermal conductivity, Molar mass, and specific heat ratio also change with changing temperature conditions, these influences on the flow field are typically negligible compared to the heating rates, associated with chemical reactions taking place.

The outlet of the supersonic combustor may be designed to end when the chemical “freezing” point occurs. As this point, the supersonic combustor may transition into a supersonic discharge as described above.

In order for locating the point in the flowfield described by Eq. 14, an equilibrium and/or kinetics solver may be used to assess \dot{h}_{rxn,e} and \dot{h}_{rxn,real}. Several existing software packages (e.g., Chemical Equilibrium Analysis and Cantera) may be used to calculate \dot{h}_{rxn,e}. These software programs typically compute total enthalpy of a gas (including both chemical energy and thermal energy rate of change)

$$\begin{matrix}{\dot{h}}_{e} = {\dot{h}}_{rxn , e} + {c}_{p , e} \frac{d T}{d t} & ( 15 ) \\ {\dot{h}}_{e , real} = {\dot{h}}_{rxn , real} + {c}_{p , e} \frac{d T}{d t} & ( 16 )\end{matrix}$$

Combining Eq. 14, 15, 16 the freezing point location in the nozzle may be estimated from the more common commercial chemical analysis software output condition of total enthalpy

\dot{h}ᵣₑₐₗ=\dot{h}ₑ; (17)

The shifting equilibrium rate of enthalpy change is calculated from

$${\dot{h}}_{e} = {u}_{r} \frac{d {h}_{e}}{d r} \qquad ( 18 )$$

Eq. 18 can be approximated on a grid in the radius domain while iteratively solving Eqs. 9-12

$${\dot{h}}_{e} \approx {u}_{r} \frac{{h}_{e} ( r + Δ r ) - {h}_{e} ( r )}{Δ r} \qquad ( 19 )$$

\dot{h}ᵣₑₐₗ can be estimated using a chemical kinetics solver such as Cantera or Chemkin coupled with a reaction mechanism such as GRI Mech 3.0. On very short timescale, Δt=Δr/uᵣ, where changes in pressure and temperature are small, a constant pressure, constant temperature reactor model is a reasonable approximation for the chemical kinetics reactor model. The chemistry associated with the pressure and temperature at state r may be loaded into the reactor. The temperature and pressure at state r+Δr may then be shifted based on Eq. 9-12. The time for this perturbation of the gas chemistry at the specified pressure and temperature to normally equilibrate, Δtᵣₑₐₗ, may be approximated

$${\dot{h}}_{real} = \frac{{h}_{e} ( r + Δ r ) - {h}_{e} ( r )}{Δ {t}_{real}} \qquad ( 20 )$$

Other similar methods or more sophisticated methods may be used to estimate the chemical freezing point including using CFD solvers with reacting flow. In such a case, the freezing point may be determined by locating the point in the flowfield where changes in exhaust gas chemistry become negligible.

In order to design the nozzle contour of the Supersonic Discharge, a method of characteristics analysis may be applied knowing the radial velocity vector field exiting the supersonic combustor and entering the Supersonic Discharge. This is a very similar design process to a conventional method-of-characteristics design of the supersonic portion of a rocket bell nozzle, but with a modified inlet velocity field condition. Other CFD and numerical techniques may also be used to produce the Supersonic Discharge profile, which ultimately produce nozzle contours that don't produce significant shockwave formation inside the Supersonic Discharge.

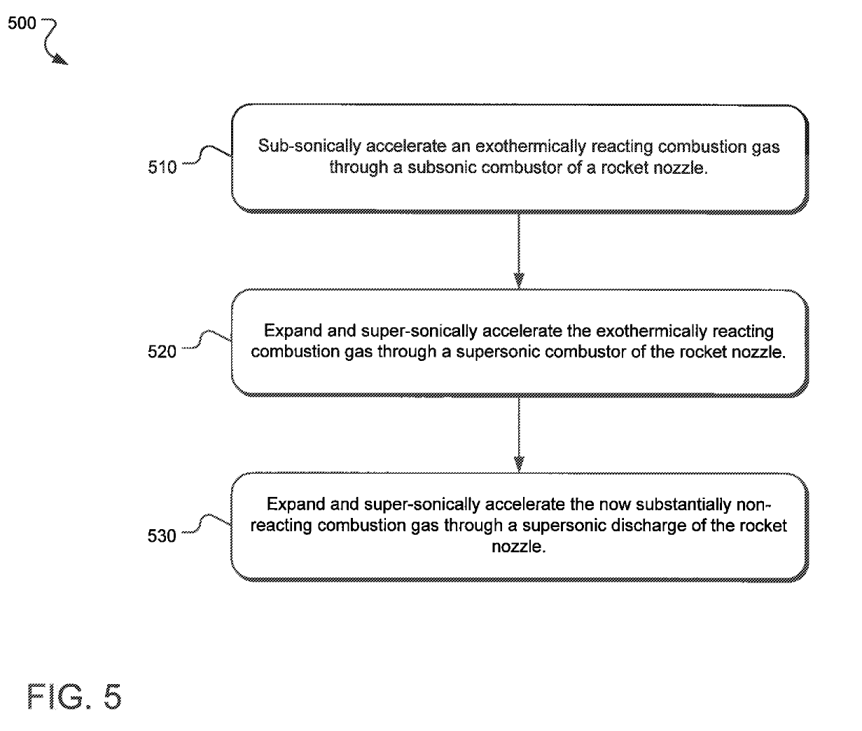

FIG. 5 illustrates example operations 500 for extracting exothermic energy from a combustion gas within a supersonic combustor rocket nozzle. Operation 510 sub-sonically accelerates an exothermically reacting combustion gas through a subsonic combustor of a rocket nozzle. The subsonic combustor has a reducing cross-sectional area along its length in the direction of combustion gas flow and has a throat at its end. The throat represents the smallest cross-sectional area within the rocket nozzle and the point at which the combustion gas reaches sonic velocity.

Operation 520 expands and super-sonically accelerates the exothermically reacting combustion gas through a supersonic combustor of the rocket nozzle. The supersonic combustor has an increasing cross-sectional area along its length in the direction of combustion gas flow. Further, the increasing cross-sectional area of the supersonic combustor does not turn into itself in order to prevent shockwaves from impeding the momentum of the accelerating combustion gas. In one implementation, the dimensions of the supersonic combustor are selected such that the supersonic combustor achieves a slow rate of cooling and decay of gas pressure of the combustion gasses without creating shockwaves within the supersonic combustor.

Operation 530 expands and super-sonically accelerates the now substantially non-reacting combustion gas through a supersonic discharge section of the rocket nozzle. The supersonic discharge has more rapidly increasing cross-sectional area along its length in the direction of combustion gas flow as compared to the supersonic combustor. As a result, the combustion gas is cooled rapidly enough to “freeze” the chemistry of the combustion gas. Therefore, the combustion gas flowing through the supersonic discharge is substantially non-reacting. The momentum of the combustion gas leaving the supersonic discharge propels the rocket nozzle in the opposite direction due to the principle of Conservation of Momentum.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

1. A rocket nozzle comprising:
a supersonic combustor oriented downstream of a rocket nozzle throat and configured to extract exothermic chemical energy from a combustion gas using a shifting chemical equilibrium within the combustion gas, wherein the combustion gas is accelerating at supersonic speeds.

2. The rocket nozzle of claim 1, wherein the supersonic combustor monotonically expands in the direction of the combustion gas flow.

3. The rocket nozzle of claim 1, wherein the supersonic combustor is conical.

4. The rocket nozzle of claim 1, wherein an area expansion ratio of the supersonic combustor is limited to between a multiplication factor of 1.025 and 25 of the rocket nozzle throat.

5. The rocket nozzle of claim 1, wherein real finite rates of change of gas enthalpy within the supersonic combustor are greater than chemical reaction rates required to maintain equilibrium conditions within the supersonic combustor.

6. The rocket nozzle of claim 1, wherein constituent components of the combustion gas shift to lower energy states within the supersonic combustor to extract the exothermic chemical energy from the combustion gas.

7. The rocket nozzle of claim 1, wherein the extracted exothermic chemical energy contributes to propulsion of the rocket nozzle.

8. A method comprising:
extracting exothermic chemical energy from a combustion gas using a shifting chemical equilibrium within the combustion gas, wherein the combustion gas is accelerating at supersonic speeds; and
discharging the combustion gas accelerating at supersonic speeds.

9. The method of claim 8, wherein the combustion gas is expanded at a first rate in the extracting operation and expanded at a second rate in the discharging operation.

10. The method of claim 9, wherein the first rate of expansion is less than the second rate of expansion.

11. The method of claim 9, wherein the first rate of expansion causes real finite rates of change of gas enthalpy greater than chemical reaction rates required to maintain equilibrium conditions.

12. The method of claim 9, wherein the second rate of expansion causes real finite rates of change of gas enthalpy less than chemical reaction rates required to maintain equilibrium conditions.

13. The method of claim 8, wherein the second extracting operation occurs within a supersonic combustor.

14. The method of claim 8, further comprising:
propelling a rocket nozzle in a direction opposite of the discharged combustion gas.

15. A nozzle comprising:
a supersonic combustor configured to extract exothermic chemical energy from a combustion gas using a shifting chemical equilibrium within the combustion gas, wherein the combustion gas is accelerating at supersonic speeds; and
a supersonic discharge configured to discharge the combustion gas accelerating at supersonic speeds.

16. The nozzle of claim 23, wherein the supersonic combustor is oriented between the subsonic combustor and the supersonic discharge.

17. The nozzle of claim 23, wherein a rocket nozzle throat is oriented between the subsonic combustor and the supersonic combustor.

18. The nozzle of claim 15, wherein real finite rates of change of gas enthalpy within the supersonic combustor are greater than chemical reaction rates required to maintain equilibrium conditions within the supersonic combustor.

19. The nozzle of claim 15, wherein real finite rates of change of gas enthalpy within the supersonic discharge are less than chemical reaction rates required to maintain equilibrium conditions within the supersonic discharge.

20. The nozzle of claim 15, wherein the extracted exothermic chemical energy contributes to propulsion of the rocket nozzle.

21. The rocket nozzle of claim 1, a supersonic discharge configured to discharge the combustion gas accelerating at supersonic speeds.

22. The method of claim 8, further comprising:
extracting exothermic chemical energy from a combustion gas accelerating at subsonic speeds.

23. The nozzle of claim 15, further comprising:
a subsonic combustor configured to extract exothermic chemical energy from a combustion gas accelerating at subsonic speeds.
